(19) United States
(12) Patent Application Publication
(10) Pub. No.: US 2020/0263477 A1
(43) Pub. Date: Aug. 20, 2020

(54) METHOD FOR CONTROLLING A LIFTGATE OF A MOTOR VEHICLE, CONTROL DEVICE FOR A LIFTGATE ASSEMBLY, LIFTGATE ASSEMBLY AND MOTOR VEHICLE

(71) Applicant: Conti Temic Microelectronic GmbH, Nürnberg (DE)

(72) Inventor: Erwin Kessler, München (DE)

(21) Appl. No.: 16/755,227

(22) PCT Filed: Oct. 12, 2018
(86) PCT No.: PCT/EP2018/077820

§ 371 Date: Apr. 10, 2020

(30) Foreign Application Priority Data
Oct. 13, 2017 (DE) 10 2017 218 391.8

(51) Int. Cl. E05F 15/616; E05F 5/00

(52) U.S. Cl. CPC E05F 15/616; E05F 5/00; E05Y 2201/21; E05Y 2900/548; E05Y 2400/41; E05Y 2800/234; E05Y 2400/302

(57) ABSTRACT

A method for controlling a liftgate of a motor vehicle in order to automatically move the liftgate from a closed position into an open position or from the open position into the closed position, wherein to move the liftgate a first and a second drive unit are activated, which each couple the liftgate to a motor vehicle component relative to which the liftgate is moved, wherein in the case that a drive force necessary to move the liftgate is below a predefined limit value, a braking operation is started in which the first and second drive units are activated such that the first drive unit exerts on the liftgate a force directed in a first direction in order to move the liftgate, and the second drive unit exerts on the liftgate a braking force at least partially opposite the first direction.

### CROSS REFERENCE TO RELATED APPLICATIONS

This application is the U.S. National Phase Application of PCT International Application No. PCT/EP2018/077820, filed Oct. 12, 2018, which claims priority to German Patent Application No. 10 2017 218 391.8, filed Oct. 13, 2017, the contents of such applications being incorporated by reference herein.

### FIELD OF THE INVENTION

The invention concerns a method for controlling a liftgate of a motor vehicle in order to automatically move the liftgate from a closed position into an open position or from the open position into the closed position, wherein to move the liftgate a first and a second drive unit are activated, which each couple the liftgate to a motor vehicle component relative to which the liftgate is moved. The invention also concerns a control device, a liftgate assembly for a motor vehicle, and a motor vehicle with such a liftgate assembly.

### BACKGROUND OF THE INVENTION

In liftgate assemblies known from the prior art, usually a liftgate is coupled to a body component of the motor vehicle via a rotational hinge, and one or more motorized gear units are arranged between the liftgate and this body component, which automatically move the liftgate in the opening or closing direction. Furthermore, such liftgate assemblies also comprise one or more springs which press in the opening direction and at least partially compensate for the weight of the liftgate. The position of the liftgate relative to the drive units and springs changes during an opening or closing process of the liftgate. Accordingly, the force ratios also change with the opening angle of the liftgate. In addition, the force ratios change depending on the vehicle inclination. Furthermore, the force acting on the motorized gear unit or spring system from the liftgate may also vary depending on external factors, such as for example ice or snow on the liftgate. This leads to problems, in particular in combination with the fact that drive units usually have a gear play or gear backlash of greater or lesser amount. Because the force ratios can change during the opening or closing process, during movement of the liftgate the gear play may be compensated, which can lead to a perceptible movement change on opening or closing the liftgate. It would however be desirable to provide as even, continuous and hence harmonious a liftgate movement as possible during opening and closing of the liftgate.

### SUMMARY OF THE INVENTION

An aspect of the present invention is a method for controlling a liftgate of a motor vehicle, a control device for a liftgate assembly, a liftgate assembly and a motor vehicle, by means of which as harmonious as possible a liftgate movement can be achieved on opening and/or closing the liftgate.

This is achieved by a method, a control device, a liftgate assembly and a motor vehicle with the features given in the respective independent claims. The dependent claims, the description and the figures relate to advantageous embodiments of the invention.

In the method according to an aspect of the invention for controlling a liftgate of a motor vehicle, in order to automatically move the liftgate from a closed position into an open position or from the open position into the closed position, to move the liftgate a first and a second drive unit are activated, which each couple the liftgate to a motor vehicle component relative to which the liftgate is moved. In addition, in the case that a drive force necessary to move the liftgate is below a predefined limit value, a braking operation is started in which the first and second drive units are activated such that the first drive unit exerts on the liftgate a force directed in a first direction in order to move the liftgate, and the second drive unit exerts on the liftgate a braking force at least partially opposite the first direction.

An aspect of the invention is based on the knowledge that play in a gear mechanism is compensated if the force ratios between the spring forces acting on the liftgate and the part of the weight force of the liftgate acting against these change during the opening or closing process of the liftgate. This change takes place accordingly if the spring forces and weight force portions of the liftgate are in equilibrium or pass through this equilibrium point. This means that the drive force necessary to move the liftgate is very small during this time in which the play compensation takes place. According to an aspect of the invention, this circumstance can now be advantageously utilized in order, precisely when the drive force necessary to move the liftgate is below a predefined limit value, to switch into a braking operation in which, accordingly, only the first drive unit moves the liftgate by exerting the force on the liftgate in the first direction, while the second drive unit exerts on the liftgate an at least partially opposite braking force, whereby the play compensation of the gear mechanism can advantageously be suppressed for the drive relevant for the continuation of the movement.

By providing the predefined limit value, it can advantageously be achieved that the braking by the second drive unit begins in good time before the play compensation of the drive relevant for the continuation of the movement, and this is suppressed accordingly, whereby a harmonious liftgate movement is achieved both on opening and closing of the liftgate.

The drive units may be configured arbitrarily, such as for example as spindle drives or as compact drives. Also, one or more spring elements may be provided which at least partially compensate for the weight force of the liftgate. Such a spring element may for example also be integrated in one or both of the drive units, and/or one or more spring elements may also be provided separately, i.e. physically separately from the respective drive units.

The first drive unit may for example comprise an actuator which can be moved in and against the first direction, and which is coupled to the liftgate for example via a hinge. The first direction need not therefore be temporally constant in relation to the liftgate or motor vehicle component, but may also change accordingly relative to these components during movement of the liftgate. The second drive unit may be configured in the same way as the first drive unit, and in addition it is advantageous if the two drive units are arranged symmetrically relative to the liftgate, but this need not necessarily be the case. With such a symmetrical arrangement, the braking force exerted on the liftgate by the second drive unit during braking operation may run parallel to the force exerted on the liftgate by the first drive unit, but in the opposite direction. However, at least part of the braking force provided by the second drive unit acts against the first direction.

This braking operation may in addition be used both on automatic opening of the liftgate and on automatic closing of the liftgate. The open position and the closed position here define the two end positions between which the liftgate can be moved automatically. It is also conceivable that not only a single first drive unit and a single second drive unit are provided, but also several first and/or second drive units.

In an advantageous embodiment of the invention, if the braking operation is started, the second drive unit is activated such that the part of the braking force acting opposite the first direction increases continuously in amount up to a predefined maximum value. The continuously acting braking force advantageously avoids the initiation of this braking operation having a negative effect on the harmonious and continuous liftgate movement. This predefined maximum value for the braking force is in particular dimensioned such that at least the part of the braking force acting against the first direction is smaller in amount than the force exerted in the first direction by the first drive unit. This ensures that, despite the braking force exerted by the second drive unit, the first drive unit continues to move the liftgate in the desired direction, i.e. in the direction of the closed position in the case of an automatic closing process, or in the direction of the open position for an automatic opening process of the liftgate.

In a further advantageous embodiment of the invention, for the case that the drive force necessary to move the liftgate is equal to or greater than the predefined limit value, the first and second drive units are activated according to normal operation such that the first drive unit exerts on the liftgate a force directed in the first direction, and the second drive unit exerts on the liftgate a force acting at least partially in the first direction. Accordingly, in normal operation, both drive units contribute to moving the liftgate. In principle, it would also be conceivable that in normal operation, the liftgate is moved only by the first drive unit or also only by the second drive unit. However, the fact that in normal operation, both drive units contribute to moving the liftgate, has the advantage that the drive force necessary to move the liftgate can be divided between the two drive units, so that again the individual drive units may themselves be designed for significantly lower drive forces, which allows the drive units to be designed more compactly and more economically. Secondly, it is thereby also possible to provide a significantly greater total drive force than if the liftgate were moved only by one e.g. the first drive unit, so that in the case of a heavy liftgate, in particular in the case of ice or snow thereon, a reliable opening of the liftgate may be ensured.

Here it is particularly advantageous if, in normal operation, the first and second drive units are activated such that the force exerted on the liftgate by the first drive unit and the force exerted on the liftgate by the second drive unit are equal or at least substantially equal. The load to be driven may thus advantageously be evenly divided over the two drive units. In this way, the control of the drive motors of the two drive units is also simpler, since in particular the motor rotation speed of the two drive systems, i.e. the two drive units, is at least approximately identical because of the usually relatively rigid coupling via the liftgate.

Furthermore, it is advantageous if, as already stated, the drive units are arranged symmetrically relative to the centre of gravity of the liftgate, or in particular relative to an axis through the centre of gravity of the liftgate, so that the part of the weight force of the liftgate acting on the two drive units is divided as evenly as possible over the two drive units. This too advantageously promotes the implementation of as harmonious and even a liftgate movement as possible.

In a further advantageous embodiment of the invention, if in braking operation it is detected that the drive force is equal to or exceeds the limit value, operation switches from braking operation to normal operation. If therefore the force ratios change again during the liftgate movement and during the braking operation, so that the drive force necessary to move the liftgate is equal to or exceeds the limit value, now advantageously operation may again switch from braking operation to normal operation and both drive units contribute to moving the liftgate, preferably in the same fashion or in the same proportions.

Here again it is advantageous if the switch from braking operation to normal operation takes place such that the braking force exerted by the second drive unit is continuously reduced to zero, and in particular immediately afterwards, in the same fashion, is continuously increased again at least partly as the force acting on the liftgate in the first direction increases, for example until the second drive unit contributes to the movement of the liftgate in the same fashion as the first drive unit.

In a further advantageous embodiment of the invention, the first and second drive units each have a drive motor powered with a motor current, wherein the present drive force necessary to move the liftgate is determined depending on the present motor current or present motor power. Thus advantageously the present drive force may be determined from the present motor currents or the power required by the respective drive motors of the respective drive units to move the liftgate. In this way, it can be detected in a simple fashion, in particular by measuring the respective motor currents or motor power, whether or not the present drive force is below the predefined limit value, or whether it exceeds this. However, whether the drive force is below or exceeds this limit value may also be implicitly detected in that a corresponding limit value is predefined for the sum of the respective motor powers or motor currents taking into account the present operating state, i.e. braking operation or normal operation. For example, for the case that the drive units are already operating in braking mode, the respective motor power levels or motor currents with different preceding signs should be taken into account.

Furthermore, in normal operation the above-mentioned division of load as evenly as possible over the two drive units may also be implemented or regulated depending on the motor currents.

Moreover, an aspect of the invention also concerns a control device for a liftgate assembly with a vehicle component, a liftgate arranged so as to be movable relative to the vehicle component, a first drive unit and a second drive unit, wherein the control device is configured to activate the first and second drive units in order to move the liftgate from a closed position into an open position or from the open position into the closed position. In addition, the control device is configured, in the case that a drive force necessary to move the liftgate is below a predefined limit value, to start a braking operation in which the control device activates the first and second drive units such that the first drive unit exerts on the liftgate a force directed in a first direction, and the second drive unit exerts on the liftgate a braking force at least partially opposite the first direction.

Furthermore, an aspect of the invention also concerns a liftgate assembly with a control device according to an aspect of the invention.

It is furthermore advantageous if the liftgate assembly has at least one spring element, such as for example a conventional coil spring or preferably a gas compression spring. The at least one spring element is preferably configured, at least for the majority of intermediate positions of the liftgate between the open and the closed position of the liftgate, to exert on the liftgate a force which at least partially, in particular largely compensates for the portion of the weight force of the liftgate acting on the first and/or second drive unit.

Furthermore, an aspect of the invention also concerns a motor vehicle with a liftgate assembly according to an aspect of the invention or one of its embodiments.

The advantages cited for the method according to an aspect of the invention and its embodiments apply similarly to the control device according to an aspect of the invention, the liftgate assembly according to an aspect of the invention and its embodiments, and also to the motor vehicle according to an aspect of the invention and its embodiments.

In addition, the method steps cited in connection with the method according to an aspect of the invention allow the refinement of the liftgate assembly according to an aspect of the invention and the motor vehicle according to an aspect of the invention with further corresponding objective features.

### BRIEF DESCRIPTION OF THE DRAWINGS

An exemplary embodiment of an aspect of the invention is described below. For this purpose, the figures show:

FIG. 1 is a schematic depiction of a liftgate assembly in a side view according to an exemplary embodiment of the present invention;

FIG. 2A is a schematic depiction of a liftgate assembly to illustrate the play compensation in a first situation;

FIG. 2B is a schematic depiction of a liftgate assembly to illustrate the play compensation in a second situation; and

FIG. 3 is a schematic depiction of a liftgate assembly according to a further exemplary embodiment of the invention.

### DETAILED DESCRIPTION OF THE PREFERRED EMBODIMENTS

The exemplary embodiment explained below is a preferred embodiment of the invention. In the exemplary embodiment, the described components of the embodiment each represent individual features of an aspect of the invention that should be considered independently of one another, and that each also develop an aspect of the invention independently of one another and can therefore also be considered to be part of an aspect of the invention, either individually or in a combination other than that shown. Furthermore, the embodiment described may also be supplemented by further features of an aspect of the invention from among those which have already been described.

In the figures, functionally identical elements are respectively provided with the same reference signs.

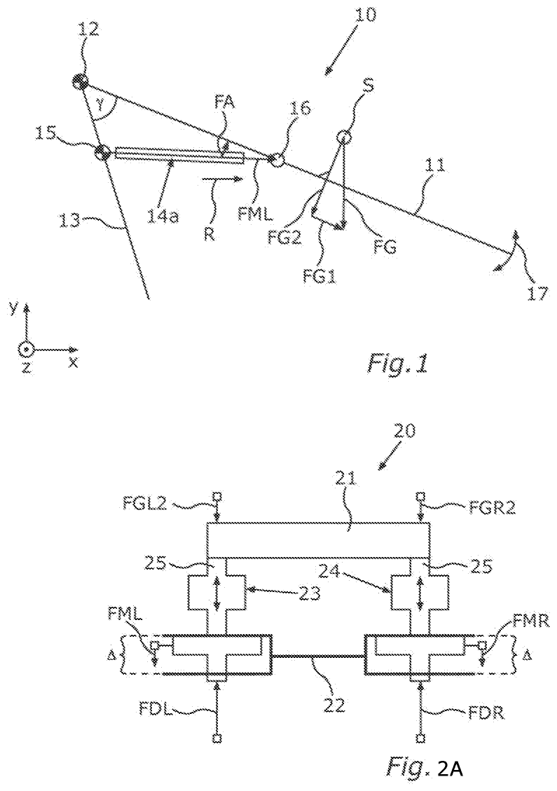

FIG. 1 shows a schematic depiction of a liftgate assembly 10 in a side view according to an exemplary embodiment of the invention. The liftgate assembly 10 has a liftgate 11 which is here illustrated schematically only as a line. This depiction serves merely to illustrate the forces acting on the liftgate 11. The liftgate 11 is here connected to a motor vehicle component 13, such as for example a body component, via a first hinge 12, such as for example a rotary hinge. Furthermore, a first drive unit 14a is arranged between this body component 13 and the liftgate 11. This first drive unit 14a may in addition be coupled to the body component 13 on one side and to the liftgate 11 on the other side via a second hinge 15 and a third hinge 16. The liftgate assembly 10 furthermore has a second drive unit 14b which is not shown in this illustration (see FIG. 3).

The x-y plane depicted herein may for example correspond to a motor vehicle plane which is spanned by the vehicle vertical axis and the vehicle longitudinal axis. The centre of gravity of the liftgate 11 is designated S in this illustration. The weight force FG of the liftgate 11 acts on the centre of gravity S of the liftgate 11. This force may in turn be broken down into a portion FG1 running along the liftgate 11 and a portion FG2 standing perpendicularly to the liftgate. The portion FG1 of the weight force FG running along the liftgate 11 is received by the hinge 12. The portion FG2 running perpendicularly to the liftgate 11 must be compensated in order to open the liftgate or in order to close this in a controlled fashion, for example with a constant angular speed. The liftgate assembly 10 may furthermore have a spring unit (not shown), such as for example a gas compression spring. Such a spring unit may for example be also integrated in the drive units 14a, 14b. This spring unit may compensate for part of the weight force component FG2. The remainder is compensated by a corresponding drive force of the drive unit 14a, 14b. The force necessary for compensation is here designated FA. This can now be divided over the two drive units 14a, 14b. However for the sake of simplicity, it is assumed below that this remaining force FA is compensated only by the first drive unit 14. This remaining force FA may in turn be divided into a force component FML running parallel to the drive direction R of the drive unit 14a, and again a component running along the liftgate 11 which is compensated by the hinge 12.

On movement of the liftgate, which is illustrated by the arrow 17, the inclination of the liftgate 11 relative to the direction of the weight force FG also changes. Accordingly, the part forces FG1 and FG2 also change, as does the force compensated by the spring unit and the force FA still to be compensated by the drive unit 14a, and its portion FML working in or against the drive direction R. In other words, the drive force FML to be applied by the drive unit 14a in order to move the liftgate 11 is dependent on the opening angle of the liftgate 11, which is here designated γ.

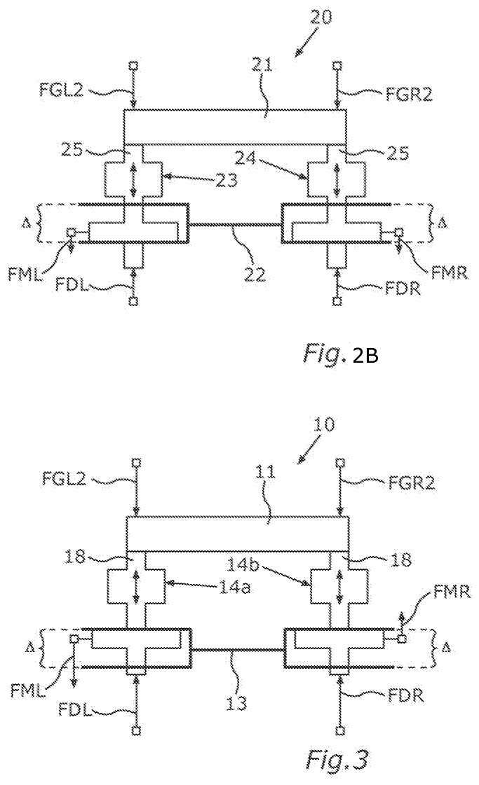

If also the vehicle inclination relative to the horizontal changes, the force ratios also change. In particular in combination with the fact that drive units usually have a greater or lesser amount of gear play or gear backlash A (see FIGS. 2A and 2B), in liftgate assemblies according to the prior art this leads to problems since, because the force ratios may change during the opening process or closing process, during movement of the liftgate a play compensation for the gear play A may occur, which leads to a perceptible jerk in opening or closing the liftgate and hence adversely affects the desired harmonious liftgate movement. This will be explained in more detail with respect to FIGS. 2A and 2B.

FIGS. 2A and 2B each show a schematic depiction of a liftgate assembly 20 to illustrate the play compensation. This liftgate assembly 20 again has a liftgate 21, a body component 22, and a first drive unit 23 and a second drive unit 24 which couple the body component 22 to the liftgate 21. Each of these gear units or drive units 23, 24 has a gear backlash A, i.e. the respective actuators 25 of the respective drive units 23 can move freely in principle within this gear backlash A, i.e. depending on the external forces acting thereon. The position of the actuators relative to the components of the gear mechanism fixed to the body depends on the forces acting on the actuators 25. These are firstly the parts of the weight force of the liftgate 21 acting on the respective drive units 23, here designated FGL2 and FGR2. Spring forces FDL, FDR from two spring units (not shown) are directed opposite these. Furthermore, the respective drive units 23, 24 exert drive forces FML and FMR in the same direction on the respective actuators 26.

For the case that, as shown in FIG. 2A, the sum of the force parts FGL2 and FGR2 of the weight force is less than the sum of the spring forces FDL and FDR, the respective actuator 25 is at the top stop of the gear play. If however the force ratios change on movement of the liftgate 21 such that the sum of the force parts FGL2 and FGR2 of the weight force are now greater than the sum of the spring forces FDL and FDR, as shown in FIG. 2B, the play is compensated and the respective actuator 25 changes its position to the bottom stop of the gear play. This play compensation causes the liftgate to perform a brief acceleration in the movement direction, which is expressed in a jerky movement of the liftgate 21.

This can now advantageously be avoided by the exemplary embodiment of the invention shown in FIG. 3. FIG. 3 shows a schematic depiction of a liftgate assembly 10 according to an exemplary embodiment of the invention. This liftgate assembly 10 again has a liftgate 11, a body component 13, and a first drive unit 14a and a second drive unit 14b which couple the body component 13 to the liftgate 11. Each of these drive units 14a, 14b has a gear mechanism with a gear backlash A and a respective actuator 18 for moving the liftgate 11. Again, firstly the force components FGL2, FGR2 of the weight force of the liftgate 21 acting on the respective drive units 14a, 14b, and also the opposite spring forces FDL, FDR from two spring units (not shown) act on these actuators 18, wherein in this exemplary embodiment a respective spring unit is assigned to each drive unit 14a, 14b.

According to this exemplary embodiment of the invention, it is now advantageously provided that, in the situation shown, to move the liftgate 11, only the first drive unit 14a exerts on the liftgate 11 via the corresponding actuator 18 a drive force FML directed in a corresponding direction, while the second drive unit 14b exerts on the liftgate 11 via the corresponding actuator 18 an opposingly directed force FMR which accordingly acts as a brake. In this way, advantageously, the play compensation for the gear play A in the drive unit 14a relevant for the liftgate movement can be suppressed, because if in this example, in the way described with respect to FIGS. 2A and 2B, the force ratios between the weight force components FGL2, FGR2 and spring forces FDL, FDR change, then due to the additional braking force FMR provided by the second drive unit 14b, no play compensation takes place in the drive unit 14a relevant for the liftgate movement.

Since the play compensation would take place in a region in which the sum of the weight force components FGL2, FGR2 and the sum of the spring forces FDL, FDR are at least approximately equal, i.e. in a region in which only a small drive force is required to move the liftgate 11, it is particularly advantageous if this braking operation, as shown in FIG. 3, is initiated only when the sum of the drive forces FMR, FML, to be applied by the drive units 14a, 14b in order to move the liftgate 11, is below a predefined limit value. Otherwise, the load to be driven is distributed as evenly as possible over the two drive units 14a, 14b, which hence drive the liftgate 11 in the same fashion and with drive forces FML, FMR directed in the same direction.

In this way, advantageously when opening and closing the liftgate 11, a particularly harmonious liftgate movement can be implemented. In addition, it is particularly advantageous if the braking by the second drive unit 14b is initiated slowly and continuously, and in the case that the force ratios change again during this braking operation, the braking force FMR provided by the second drive unit 14b is reduced again also slowly and continuously. Thus in a particularly advantageous fashion, the play compensation is suppressed at the driving motor which is used to regulate the liftgate speed.

To summarise, the play suppression in the drive unit responsible for the liftgate speed, i.e. in this example the first drive unit 14a, allows a more harmonious liftgate movement and compensation for the influence of system parameters, which could lead to operation with play compensation due to the shift in force equilibrium and hence disrupt the liftgate movement.

Overall, the example shows how an aspect of the invention can provide a suppression of the play compensation in liftgate systems with two drive units.

### LIST OF REFERENCE SIGNS

10 Liftgate assembly
11 Liftgate
12 Hinge
13 Motor vehicle component
14a First drive unit
14b Second drive unit
15 Hinge
16 Hinge
17 Arrow
18 Actuator
20 Liftgate assembly
21 Liftgate
22 Body component
23 First drive unit
24 Second drive unit
25 Actuator
FG Weight force
FG1 Weight force part
FG2 Weight force part
FGL2 Weight force part
FGR2 Weight force part
FA Force
FML Drive force of first drive unit
FMR Drive force of second drive unit
FDL Spring force
FDR Spring force
R Drive direction
S Centre of gravity
Δ Gear backlash
γ Opening angle

1. A method for controlling a liftgate of a motor vehicle in order to automatically move the liftgate from a closed position into an open position or from the open position into the closed position, wherein to move the liftgate a first and a second drive unit are activated, which each couple the liftgate to a motor vehicle component relative to which the liftgate is moved,
wherein
in the case that a drive force necessary to move the liftgate is below a predefined limit value, a braking operation is started in which the first and second drive units are activated such that the first drive unit exerts on the liftgate a force directed in a first direction in order to move the liftgate, and the second drive unit exerts on the liftgate a braking force at least partially opposite the first direction.

2. The method as claimed in claim 1, wherein if the braking operation is started, the second drive unit is activated such that the part of the braking force acting opposite the first direction increases continuously in amount up to a predefined maximum value.

3. The method as claimed in claim 1, wherein for the case that the drive force necessary to move the liftgate is equal to or greater than the predefined limit value, the first and second drive units are activated according to normal operation such that the first drive unit exerts on the liftgate a force directed in the first direction, and the second drive unit exerts on the liftgate a force acting at least partially in the first direction.

4. The method as claimed in claim 1, wherein in normal operation, the first and second drive units are activated such that the force exerted on the liftgate by the first drive unit and the force exerted on the liftgate by the second drive unit are substantially equal.

5. The method as claimed in claim 1, wherein in the case that in braking operation it is detected that the drive force is equal to or exceeds the limit value, operation switches from braking operation to normal operation.

6. The method as claimed in claim 1, wherein the switch from braking operation to normal operation takes place such that the braking force exerted by the second drive unit is continuously reduced to zero.

7. The method as claimed in claim 1, wherein the first and second drive units each have a drive motor powered by current, wherein the drive force necessary to move the liftgate is determined depending on the present motor current or present motor power.

8. A control device for a liftgate assembly with a vehicle component, a liftgate arranged so as to be movable relative to the vehicle component, a first drive unit and a second drive unit, wherein the control device is configured to activate the first and second drive units so as to move the liftgate from a closed position into an open position or from the open position into the closed position,
wherein
the control device is configured, in the case that a drive force necessary to move the liftgate is below a predefined limit value, to start a braking operation in which the control device activates the first and second drive units such that the first drive unit exerts on the liftgate a force directed in a first direction in order to move the liftgate, and the second drive unit exerts on the liftgate a braking force at least partially opposite the first direction.

9. A liftgate assembly with a control device as claimed in claim 8.

10. The liftgate assembly as claimed in claim 9, wherein the liftgate assembly has at least one spring element which is configured, at least for the majority of intermediate positions between the open and the closed position of the liftgate, to exert on the liftgate a force which at least partially, in particular largely compensates for the portion of the weight force of the liftgate acting on the first and/or second drive unit.

11. A motor vehicle having a liftgate assembly as claimed in claim 9.

12. The method as claimed in claim 2, wherein for the case that the drive force necessary to move the liftgate is equal to or greater than the predefined limit value, the first and second drive units are activated according to normal operation such that the first drive unit exerts on the liftgate a force directed in the first direction, and the second drive unit exerts on the liftgate a force acting at least partially in the first direction.

13. A motor vehicle having a liftgate assembly as claimed in claim 10.
